(19) United States
(12) Patent Application Publication
(10) Pub. No.: US 2015/0098839 A1
(43) Pub. Date: Apr. 9, 2015

(54) Pump Systems and Methods

(71) Applicant: Ingersoll-Rand Company, Davidson, NC (US)

(72) Inventor: Russell Arthur Banks, Huntersville, NC (US)

(21) Appl. No.: 14/048,409

(22) Filed: Oct. 8, 2013

(51) Int. Cl. F04B 49/00; H02J 7/00

(52) U.S. Cl. CPC F04B 49/002; H02J 7/0052
USPC 417/53; 417/244; 320/107

(57) ABSTRACT

Illustrative embodiments of a pump systems and methods are disclosed. In at least one embodiment, a pump system includes a main pump including an inlet and an outlet and configured to supply energy to a pumped fluid. The pump system further includes a booster pump fluidly coupled to either the inlet or the outlet of the main pump such that the pumped fluid flows through a pumping chamber of the booster pump whether the booster pump is active or inactive. The booster pump is configured to modify the energy of the pumped fluid when active and to allow the pumped fluid to flow through the pumping chamber without substantially modifying the energy of the pumped fluid when inactive.

### TECHNICAL FIELD

The present disclosure relates, generally, to pump systems and methods and, more particularly, to booster pumps that may be used to augment the performance of a main pump.

### BACKGROUND

Fluid pumps are used to supply energy to a fluid medium, such as a liquid or a gas (for example, by increasing a rate of flow of the fluid). Typical fluid pumps are commercially available in a limited number of sizes, capacities, or power ratings but must be used to cover an extremely large variety of applications. For some applications, a mismatch may exist between the pumping requirements of the application and the commercially available pumps. In such applications, using an undersized pump may achieve lower quality results, and using an oversized pump may be unnecessarily expensive. Additionally, in some applications operating conditions may change over time, making selection of an appropriate pump difficult.

### SUMMARY

According to one aspect, a system may comprise a main pump including an inlet and an outlet, the main pump configured to supply energy to a pumped fluid, and a booster pump fluidly coupled to either the inlet or the outlet of the main pump such that the pumped fluid flows through a pumping chamber of the booster pump whether the booster pump is active or inactive. The booster pump may be configured to modify the energy of the pumped fluid when active and to allow the pumped fluid to flow through the pumping chamber without substantially modifying the energy of the pumped fluid when inactive.

In some embodiments, the booster pump may be configured to increase the energy of the pumped fluid when active. In other embodiments, the booster pump may be configured to decrease the energy of the pumped fluid when active. The booster pump may be an active membrane pump comprising a membrane positioned in the pumping chamber and an electromagnetic driver coupled to the membrane.

In some embodiments, the system may further comprise an energy recovery system fluidly coupled to the main pump and the booster pump, the energy recovery system configured to extract and store energy from the pumped fluid while the booster pump is inactive and to supply energy to the booster pump while the booster pump is active. The energy recovery system may comprise a generator disposed in a flow path of the pumped fluid and an electrical energy storage device coupled to the generator and configured to store energy extracted by the generator.

In some embodiments, the booster pump may be configured to be inactive whenever the main pump is inactive and to be active whenever the main pump is active. The system may further comprise an electronic controller operatively coupled to the booster pump, where the electronic controller is configured to determine whether the energy supplied to the pumped fluid by the main pump is sufficient and to activate the booster pump in response to determining that the energy supplied to the pumped fluid by the main pump is not sufficient. The system may further comprise a pressure sensor fluidly coupled to the outlet of the main pump and operatively coupled to the electronic controller to communicate pressure data to the electronic controller, where the electronic controller is configured to determine whether the energy supplied to the pumped fluid by the main pump is sufficient by analyzing the pressure data.

According to another aspect, a system may comprise a main pump including an inlet and an outlet, the main pump configured to produce fluid flow, and a booster pump fluidly coupled to the outlet of the main pump such that the fluid flow passes through a pumping chamber of the booster pump whether the booster pump is active or inactive. The booster pump may be configured to increase a rate of the fluid flow when active and to allow the fluid flow to pass through the pumping chamber without substantially decreasing the rate of the fluid flow when inactive.

In some embodiments, the booster pump may be an active membrane pump comprising a membrane positioned in the pumping chamber and an electromagnetic driver coupled to the membrane. The booster pump may further comprise an energy recovery system configured to extract and store energy from the fluid flow while the booster pump is inactive and to supply energy to the booster pump while the booster pump is active.

In some embodiments, the booster pump may be configured to be inactive whenever the main pump is inactive and to be active whenever the main pump is active. The system may further comprise an electronic controller operatively coupled to the booster pump and a pressure sensor operatively coupled to the electronic controller and configured to communicate pressure data to the electronic controller, the pressure data indicating a pressure of the fluid flow. The electronic controller may be configured to determine whether the pressure data demonstrates a predetermined relationship to a pressure threshold and to activate the booster pump in response to a determination that the pressure data demonstrates the predefined relationship to the pressure threshold.

According to yet another aspect, a method may comprise operating a main pump to supply energy to a pumped fluid, where a booster pump is coupled to either an inlet or an outlet of the main pump such that the pumped fluid flows through a pumping chamber of the booster pump whether the booster pump is active or inactive, and activating the booster pump, while operating the main pump, to modify the energy of the pumped fluid.

In some embodiments, the method may further comprise deactivating the booster pump, while operating the main pump, to allow the pumped fluid to flow through the pumping chamber of the booster pump without substantially modifying the energy of the pumped fluid. The method may further comprise extracting and storing energy from the pumped fluid before the booster pump is activated and supplying stored energy to the booster pump when activating the booster pump.

In some embodiments, activating the booster pump may comprise activating the booster pump to increase the energy of the pumped fluid. In other embodiments, activating the booster pump may comprise activating the booster pump to decrease the energy of the pumped fluid. Activating the booster pump may comprise activating the booster pump in response to determining, using an electronic controller, that the energy supplied to the pumped fluid by the main pump is not sufficient.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a pump system including a main pump using a booster pump;

FIG. 2 is a simplified block diagram of at least one embodiment of a booster pump that may be used with the pump system of FIG. 1; and

FIG. 3 is a simplified flow diagram of at least one embodiment of a method of using the pump system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the present disclosure.

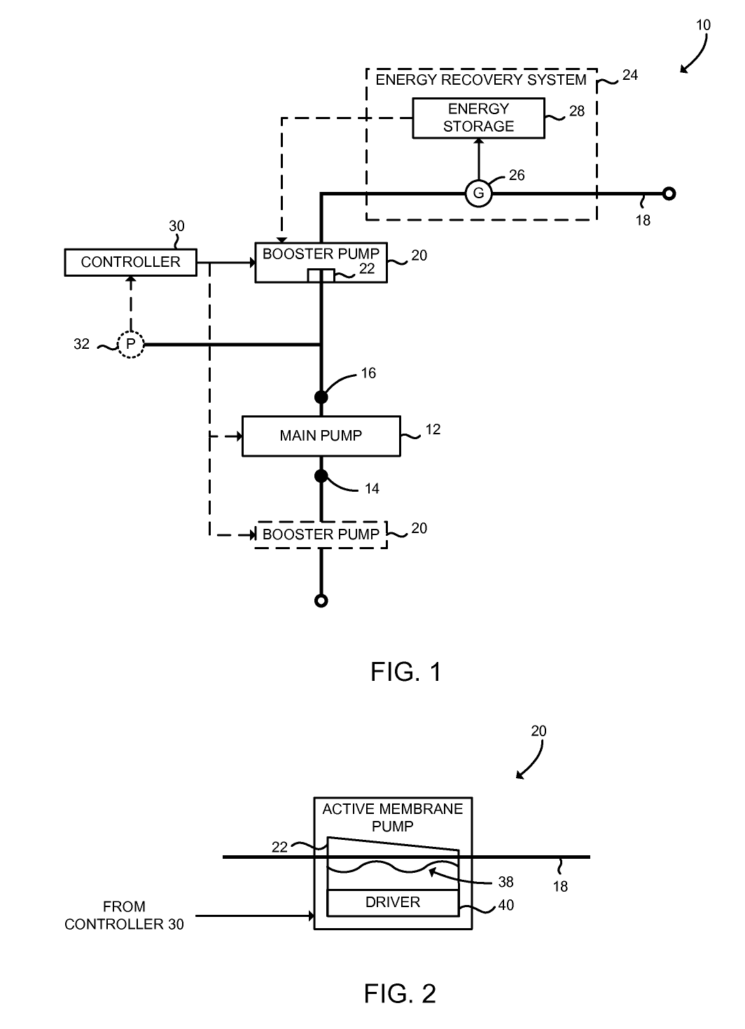

Referring now to FIG. 1, one illustrative embodiment of a pump system 10 is shown as a simplified block diagram. The pump system 10 includes a main pump 12 having an inlet 14 and an outlet 16. The main pump 12 may be embodied as any pump capable of supplying energy to a pumped fluid. For example, the main pump 12 may increase flow rate and/or pressure of the pumped fluid. The main pump 12 may be illustratively embodied as a diaphragm pump, gear pump, centrifugal pump, positive displacement pump, non-positive displacement pump, or any other suitable type of pump. The main pump 12 may use any appropriate power source, for example, the main pump 12 may be electrically powered, pneumatically powered, or hydraulically powered. The pumped fluid flows through a fluid line 18 coupled to the inlet 14 and the outlet 16. The fluid line 18 may be coupled to a fluid source, such as a fluid reservoir, as well as to one or more fluid destinations, including, but not limited to, a fluid container, a heat exchanger, a hydraulic load, or an industrial process. Although not illustrated as such in FIG. 1, in some embodiments, the fluid line 18 may be a closed loop.

The outlet 16 of the main pump 12 is fluidly coupled to a booster pump 20. The booster pump 20 may be illustratively embodied as a pump that is smaller, less-expensive, and/or less-powerful than the main pump 12. While the booster pump 20 is illustrated in FIG. 1 as a separate unit from the main pump 12, it will be appreciated that, in other embodiments, the booster pump 20 may be physically coupled to or otherwise integrated with the body of the main pump 12. When activated, the booster pump 20 modifies the energy of the fluid pumped by the main pump 12. Thus, the booster pump 20 may be used as a relatively inexpensive means to adapt the output of the main pump 12 to a particular application. In some embodiments, the booster pump 20 may be installed or selected at the same time as the main pump 12, allowing use of a less-expensive main pump 12. In other embodiments, the booster pump 20 may be retrofitted to the main pump 12 to adapt the pump system 10 to application requirements.

In the illustrative embodiment, the booster pump 20 increases the energy of the pumped fluid when active. It is contemplated that, in other embodiments, the booster pump 20 may decrease the energy of the pumped fluid when active—essentially, the booster pump 20 may be installed “backwards” to resist the flow of the pumped fluid. The booster pump 20 includes a pumping chamber 22. When the booster pump 20 is inactive, the pumped fluid flows freely through the pumping chamber 22; in other words, when inactive the booster pump 20 does not substantially modify the energy of the pumped fluid. For example, the booster pump 20 may be embodied as a non-positive displacement pump. In one illustrative embodiment, the booster pump 20 may be an active membrane pump, as described further below in connection with FIG. 2. As shown in FIG. 1, the booster pump 20 is fluidly coupled in series with the outlet 16 of the main pump 12. In other embodiments, the booster pump 20 may be fluidly coupled to the inlet 14 of the main pump 12, or at other points along the fluid line 18. Further, in some embodiments, the pump system 10 may include more than one booster pump 20 (e.g., fluidly coupled in series with the main pump 12 and any other booster pumps 20).

In some embodiments, the pump system 10 may include an energy recovery system 24 operatively coupled to the booster pump 20. While the booster pump 20 is inactive, the energy recovery system 24 extracts and stores energy from the pumped fluid. When the booster pump 20 is active, the energy recovery system 24 supplies energy to the booster pump 20. In the illustrative embodiment, the energy recovery system 24 includes a generator 26 coupled to an electrical energy storage unit 28. In some embodiments, the generator 26 may include a fan blade or impeller disposed within the fluid line 18 that is used to capture kinetic energy from the pumped fluid. In other embodiments, the generator 26 may include an electroactive polymer membrane that generates energy when flexed by the pumped fluid. The energy storage unit 28 may be embodied as a battery, a capacitor, or any other component capable of storing the electrical energy extracted by the generator 26. The energy storage unit 28 is operatively coupled to the booster pump 20 to supply electrical energy to the booster pump 20. In some embodiments, the energy recovery system 24 may be a component of, incorporated within, or otherwise integrated with the booster pump 20. For example, the generator 26 (or a portion thereof) may be disposed within the pumping chamber 22 of the booster pump 20. In some embodiments, an electroactive polymer membrane disposed within the pumping chamber 22 of the booster pump 20 may be used both to drive the pumped fluid (when the booster pump 20 is active) and to collect energy from the pumped fluid (when the booster pump 20 is inactive).

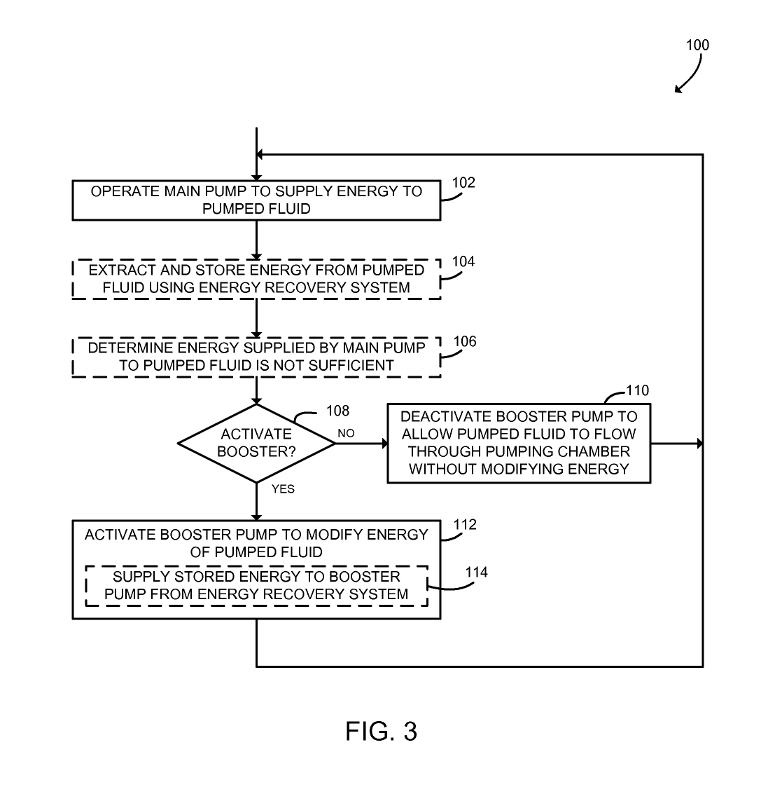

In the illustrative embodiment of FIG. 1, the booster pump 20 is operatively coupled to an electronic controller 30. In some embodiments, the controller 30 may also be operatively coupled to the main pump 12. Further, in some embodiments, the controller 30 may be operatively coupled to a pressure sensor 32. The pressure sensor 32 may be fluidly coupled to the outlet 16 of the main pump 12 and operable to measure a pressure of the pumped fluid. In other embodiments, the pressure sensor 32 may be disposed at any point along the fluid line 18 where the pressure sensor 32 will be able to measure a pressure of the pumped fluid. It should be appreciated that, in some embodiments, the controller 30 may constitute a part of the booster pump 20 and/or the main pump 12. The controller 30 may be responsible for interpreting signals sent by sensors associated with the pump system 10 (such as the pressure sensor 32) and for activating or energizing electronically-controlled components associated with the pump system 10. For example, the controller 30 may activate the booster pump 20 when needed to meet pumping requirements of the pump system 10. In particular, as described below in connection with FIG. 3, the controller 30 may be operable to determine when the booster pump 20 should be activated and/or deactivated.

To do so, the controller 30 may include a number of electronic components commonly associated with electronic control units utilized in the control of electromechanical systems. For example, the controller 30 of the pump system 10 may include a processor, an input/output (“I/O”) subsystem, and a memory, which are not illustrated in FIG. 1 so as not to obscure the present disclosure. It will be appreciated that the controller 30 may include other or additional components, such as those commonly found in a computing device (e.g., various input/output devices). Additionally, in some embodiments, one or more of the components of the controller 30 may be incorporated in, or otherwise form a portion of, another component of the controller 30 (e.g., as with a microcontroller).

Although illustrated as an electronic controller 30, it is contemplated that, in other embodiments, the controller 30 may use any suitable control technology. For example, the controller 30 may be a pneumatic controller. Such pneumatic controller 30 may be used in embodiments where the main pump 12 is air-powered. In such embodiments, the controller 30 may be coupled to the air supply and/or exhaust lines of the main pump 12, and may sense the flow or pressure of air to determine whether the main pump 12 is operating. In such embodiments, the controller 30 may activate the booster pump 20 using an electronic signal, or may activate the booster pump 20 using a pneumatic signal. As another example, in some embodiments, the controller 30 may be embodied as a simple manual control such as an on/off switch.

Referring now to FIG. 2, one illustrative embodiment of the booster pump 20 is shown as a simplified block diagram. In particular, the booster pump 20 shown in FIG. 2 is illustratively embodied as an active membrane pump having a design similar to the vibrating membrane fluid circulator described in U.S. Pat. No. 6,361,284 to Drevet, the entire disclosure of which is incorporated by reference herein. The active membrane pump 20 is an electrically powered, non-positive displacement pump. The active membrane pump 20 includes a pumping chamber 22, an elastomeric membrane 38 positioned within the pumping chamber 22, and an electromagnetic driver 40 coupled to the membrane 38. The driver 40 converts electrical signals into vibratory motion, similar to an audio speaker or other sound transducer. The driver 40 may include amplifiers, frequency generators, magnets, coils, and any other electrical circuitry required to generate the vibratory motion. The pumped fluid of the fluid line 18 flows through the pumping chamber 22 past the membrane 38. When the pump 20 is activated, the driver 40 mechanically vibrates the membrane 38 to create waves in the membrane 38. This motion of the membrane 38 creates a pressure gradient in the pumped fluid within the pumping chamber 22, imparting energy on the pumped fluid. When the driver 40 is inactive, the pumped fluid flows through the pumping chamber 22 past the membrane 38 without significant energy loss. The active membrane pump 20 may activate the driver 40 in response to one or more control signals received from the controller 30.

Referring now to FIG. 3, one illustrative embodiment of a method 100 of using the pump system 10 is shown as a simplified flow diagram. The method 100 is illustrated as a number of blocks 102-114, which may be performed by various components of the pump system 10. The method 100 begins in block 102 in which the main pump 12 is operated to supply energy to the pumped fluid. The main pump 12 may be operated continuously when power is available, in response to user input (e.g., an on/off switch) or operated under the control of an external control system (not illustrated).

Some embodiments of the method 100 may optionally employ block 104, in which the energy recovery system 24 may extract and store energy from the pumped fluid. For instance, the energy recovery system 24 may extract and store energy from the pumped fluid while the booster pump 20 is inactive. It is also contemplated that, in some embodiment, the energy recovery system 24 may extract and store energy from the pumped fluid while the booster pump 20 is active.

Some embodiments of the method 100 may also optionally employ block 106, in which the controller 30 may determine whether the energy supplied to the pumped fluid by the main pump 12 is sufficient (i.e., meets some threshold value). For example, the controller 30 may determine the pressure of the pumped fluid at the outlet 16 of the main pump 12 by analyzing data received from the pressure sensor 32. In some embodiments, the controller 30 may smooth, average, or otherwise filter the data received from the pressure sensor 32 to remove the effects of any pulsations produced by the main pump 12. After any filtering, the controller 30 may compare the measured pressure of the pumped fluid to a pressure threshold. The controller 30 may determine that the energy supplied by the main pump 12 is not sufficient when the measured pressure drops below the pressure threshold. Other methods for determining whether the energy supplied by the main pump 12 is sufficient are possible. For example, rather than measuring pressure of the pumped fluid, the controller 30 may measure the flow rate of the pumped fluid and compare the measured flow rate to a flow rate threshold. As another example, for a pneumatically powered main pump 12, the controller 30 may measure and analyze the pressure of the exhaust produced by the main pump 12 to determine whether sufficient energy is being supplied.

In block 108, the controller 30 determines whether to activate (or deactivate) the booster pump 20. In some embodiments, the controller 30 may activate the booster pump 20 when the energy supplied by the main pump 12 is not sufficient, as previously determined in optional block 106. (It is also contemplated that, in embodiments where the booster pump 20 is configured to reduce the energy of the pumped fluid, the controller 30 may activate the booster pump 20 when the main pump 12 provides excess energy.) In some embodiments, the controller 30 may include additional logic to determine whether to activate the booster pump 20 based on whether the energy supplied by main pump 12 is sufficient. For example, the controller 30 may implement a proportional-integral controller, a proportional-integral-derivative controller, or a fuzzy logic controller. In such embodiments, the energy supplied to the pumped fluid may thereby be controlled about a set point.

In other embodiments, the booster pump 20 may simply follow the activity of the main pump 12; that is, the booster pump 20 may activate when the main pump 12 is active and deactivate when the main pump 12 is not active. In such embodiments, the booster pump 20 may be electrically connected with the main pump 12 in series, automatically activating when power is supplied to the main pump 12. In other embodiments, the booster pump 20 may be configured to sense when electrical current is being supplied to the main pump 12 and activate accordingly, for example using a Hall effect current sensor positioned on the lines supplying power to the main pump 12 (not illustrated). In still other embodiments, the booster pump 20 may be controlled by a user, for example using a simple on/off switch. It should be apparent that when manually operated or configured to follow the main pump 12, the controller 30 may be significantly simplified; indeed, in the simplest embodiments the controller 30 may be replaced by a simple switch or series electrical connection to the main pump 12. If the booster pump 20 is activated, the method 100 advances to block 112, described below. If the booster pump 20 is not activated, the method 100 branches to block 110.

In block 110, the booster pump 20 may be (or remain) deactivated to allow the pumped fluid to flow through the pumping chamber 22 of the booster pump 20 without substantially modifying the energy of the pumped fluid. Allowing the pumped fluid to flow through the pumping chamber 22 allows the booster pump 20 to remain installed on the fluid line 18 even when not active, without requiring additional valves or other flow control systems. Accordingly, a non-positive displacement pump such as the active membrane pump 20 illustrated in FIG. 2 may allow flow without significant energy loss when not active. After block 110, the method 100 loops back to block 102 to continue operating the main pump 12.

Referring back to block 108, if the booster pump 20 to be activated (or remain active), the method 100 advances to block 112. In block 112, the controller 30 activates the booster pump 20 to modify the energy of the pumped fluid. As described above, the controller 30 may activate the booster pump 20 by generating an electrical control signal to activate the pumping elements of the booster pump 20. As described above, when active, the booster pump 20 may either increase or decrease the energy of the pumped fluid, as desired. In some embodiments of the method 100, block 112 may also involve block 114, in which the energy recovery system 24 supplies stored energy to the booster pump 20. Such stored energy may provide all or a portion of the energy needed to operate the booster pump 20, and the stored energy may be supplied until exhausted. After the stored energy is exhausted, the booster pump 20 may be powered by an external energy supply. After completion of block 112, the method 100 loops back to block 102 to continue operating the pump system 10.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present disclosure.

1. A system comprising:
a main pump including an inlet and an outlet, the main pump configured to supply energy to a pumped fluid; and
a booster pump fluidly coupled to either the inlet or the outlet of the main pump such that the pumped fluid flows through a pumping chamber of the booster pump whether the booster pump is active or inactive;
wherein the booster pump is configured to (i) modify the energy of the pumped fluid when active and (ii) allow the pumped fluid to flow through the pumping chamber without substantially modifying the energy of the pumped fluid when inactive.

2. The system of claim 1, wherein the booster pump is configured to increase the energy of the pumped fluid when active.

3. The system of claim 1, wherein the booster pump is configured to decrease the energy of the pumped fluid when active.

4. The system of claim 1, wherein the booster pump is an active membrane pump comprising a membrane positioned in the pumping chamber and an electromagnetic driver coupled to the membrane.

5. The system of claim 1, further comprising an energy recovery system fluidly coupled to the main pump and the booster pump, the energy recovery system configured to (i) extract and store energy from the pumped fluid while the booster pump is inactive and (ii) supply energy to the booster pump while the booster pump is active.

6. The system of claim 5, wherein the energy recovery system comprises:
a generator disposed in a flow path of the pumped fluid; and
an electrical energy storage device coupled to the generator and configured to store energy extracted by the generator.

7. The system of claim 1, wherein the booster pump is configured to be inactive whenever the main pump is inactive and to be active whenever the main pump is active.

8. The system of claim 1, further comprising an electronic controller operatively coupled to the booster pump, wherein the electronic controller is configured to (i) determine whether the energy supplied to the pumped fluid by the main pump is sufficient and (ii) activate the booster pump in response to determining that the energy supplied to the pumped fluid by the main pump is not sufficient.

9. The system of claim 8, further comprising a pressure sensor fluidly coupled to the outlet of the main pump and operatively coupled to the electronic controller to communicate pressure data to the electronic controller, wherein the electronic controller is configured to determine whether the energy supplied to the pumped fluid by the main pump is sufficient by analyzing the pressure data.

10. A system comprising:
a main pump including an inlet and an outlet, the main pump configured to produce fluid flow; and
a booster pump fluidly coupled to the outlet of the main pump such that the fluid flow passes through a pumping chamber of the booster pump whether the booster pump is active or inactive;
wherein the booster pump is configured to (i) increase a rate of the fluid flow when active and (ii) allow the fluid flow to pass through the pumping chamber without substantially decreasing the rate of the fluid flow when inactive.

11. The system of claim 10, wherein the booster pump is an active membrane pump comprising a membrane positioned in the pumping chamber and an electromagnetic driver coupled to the membrane.

12. The system of claim 10, wherein the booster pump further comprises an energy recovery system configured to (i) extract and store energy from the fluid flow while the booster pump is inactive and (ii) supply energy to the booster pump while the booster pump is active.

13. The system of claim 10, wherein the booster pump is configured to be inactive whenever the main pump is inactive and to be active whenever the main pump is active.

14. The system of claim 10, further comprising:
an electronic controller operatively coupled to the booster pump; and
a pressure sensor operatively coupled to the electronic controller and configured to communicate pressure data to the electronic controller, the pressure data indicating a pressure of the fluid flow;
wherein the electronic controller is configured to (i) determine whether the pressure data demonstrates a predetermined relationship to a pressure threshold and (ii) activate the booster pump in response to a determination that the pressure data demonstrates the predefined relationship to the pressure threshold.

15. A method comprising:
operating a main pump to supply energy to a pumped fluid, wherein a booster pump is coupled to either an inlet or an outlet of the main pump such that the pumped fluid flows through a pumping chamber of the booster pump whether the booster pump is active or inactive; and
activating the booster pump, while operating the main pump, to modify the energy of the pumped fluid.

16. The method of claim 15, further comprising deactivating the booster pump, while operating the main pump, to allow the pumped fluid to flow through the pumping chamber of the booster pump without substantially modifying the energy of the pumped fluid.

17. The system of claim 15, wherein activating the booster pump comprises activating the booster pump to increase the energy of the pumped fluid.

18. The system of claim 15, wherein activating the booster pump comprises activating the booster pump to decrease the energy of the pumped fluid.

19. The method of claim 15, further comprising:
extracting and storing energy from the pumped fluid before the booster pump is activated; and
supplying stored energy to the booster pump when activating the booster pump.

20. The method of claim 15, wherein activating the booster pump comprises activating the booster pump in response to determining, using an electronic controller, that the energy supplied to the pumped fluid by the main pump is not sufficient.
